(19) United States
(12) Patent Application Publication
(10) Pub. No.: US 2008/0289051 A1
(43) Pub. Date: Nov. 20, 2008

(54) INFORMATION PROCESSING APPARATUS AND SYSTEM, COMPUTER READABLE RECORDING MEDIUM, AND INFORMATION PROCESSING METHOD

(75) Inventors: Toru OSAMURA, Kanagawa (JP); Takanori MASUI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/967,892

(22) Filed: Dec. 31, 2007

(30) Foreign Application Priority Data
May 18, 2007 (JP) 2007-132839

(51) Int. Cl. H04L 9/32

(52) U.S. Cl. 726/28

(57) ABSTRACT

An information processing apparatus includes: an authenticating unit that authenticate a user; a registering unit that reads operation setting information registered by a user who is not the authenticated user, and registers the operation setting information as the operation setting information of the authenticated user; and a controller that performs a control operation to prohibit a disclosure or registration of the operation setting information, when the operation setting information registered by the user who is not the authenticated user includes operation setting information that is prohibited from being used by the authenticated user or being disclosed to the authenticated user.

### CROSS-REFERENCE TO RELATED APPLICATIONS

This application is based on and claims priority under 35 USC 119 from Japanese Patent Application No. 2007-132839 filed May 18, 2007.

### BACKGROUND

1. Technical Field

The present invention generally relates to an information processing apparatus and system, a computer readable recording medium, and an information processing method.

2. Related Art

In recent years, various functions such as facsimile, copying, and printing functions are mounted in image forming apparatuses equipped with an information processing apparatus, and each function is becoming more and more sophisticated. In this trend, there are cases where a user can set desired conditions after switching screens on the operation panel several times. Therefore, setting an image forming apparatus to a user's liking is particularly troublesome for the user.

### SUMMARY

According to an aspect of the invention, there is provided an information processing apparatus that includes: an authenticating unit that authenticate a user; a registering unit that reads operation setting information registered by a user who is not the authenticated user, and registers the operation setting information as the operation setting information of the authenticated user; and a controller that performs a control operation to prohibit a disclosure or registration of the operation setting information, when the operation setting information registered by the user who is not the authenticated user includes operation setting information that is prohibited from being used by the authenticated user or being disclosed to the authenticated user.

### BRIEF DESCRIPTION OF THE DRAWINGS

Exemplary embodiments of the present invention will be described in detail based on the following figures, wherein:

FIG. 1 is a block diagram showing the structure of an image forming apparatus;

FIG. 2 is a block diagram showing the hardware structure of the controller;

FIG. 3 shows the data structure to be stored in the memory;

FIG. 4 shows the system structure;

FIG. 5 shows an example of setting data;

FIGS. 6A through 6C show examples of setting data;

FIGS. 7A and 7B show examples of setting data;

FIGS. 8A and 8B are flowcharts showing the procedures to be carried out by the controller when the setting data is stored in the apparatus;

FIG. 9 is a flowchart showing the procedures to be carried out by the controller when the setting data is stored in another device; and

FIG. 10 is a flowchart showing the procedures to be carried out by the other device that receives a request to obtain the setting data.

### DETAILED DESCRIPTION

The following is a description of an exemplary embodiment of the present invention, with reference to the accompanying drawings.

### Exemplary Embodiment

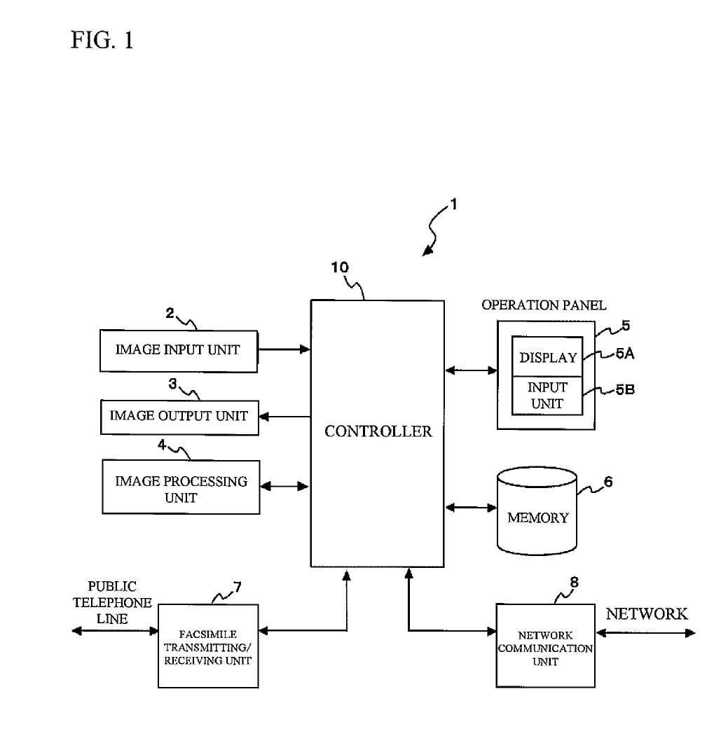

FIG. 1 shows the entire structure of an image forming apparatus 1 of this exemplary embodiment to which an information processing apparatus is applied. The image forming apparatus 1 shown in FIG. 1 is a so-called complex machine, and has a print function, a copy function, a facsimile transmission/reception function, as described later. The present invention is of course applicable to other various apparatuses such as copying machines, printers, and facsimile machines.

The image forming apparatus 1 includes an image input unit 2, an image output unit 3, an image processing unit 4, an operation panel 5, a memory 6, a facsimile transmitting/receiving unit 7, a network communication unit 8, and a controller 10.

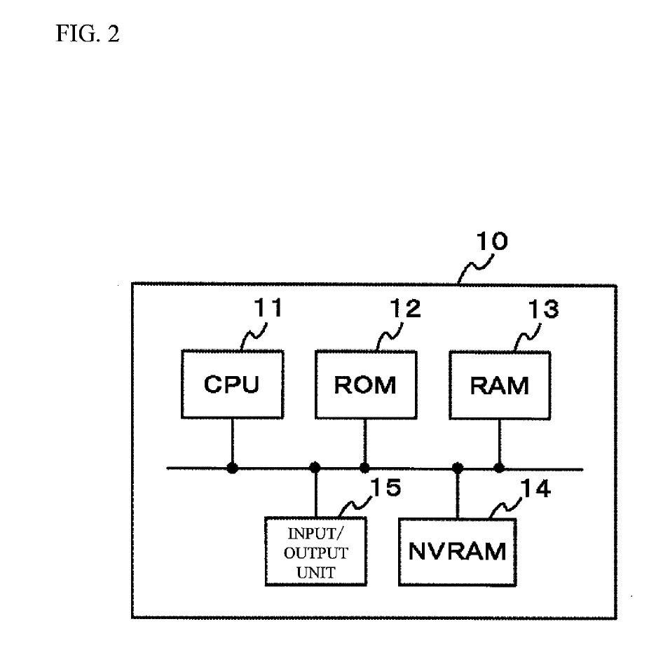

The controller 10 controls the operation of each functional unit, and includes a CPU 11, a ROM 12, a RAM 13, a NVRAM (Non-Volatile RAM) 14, and an input/output unit 15, as shown in FIG. 2. The CPU 11 reads a program stored in the ROM 12, and performs an operation in accordance with this program, so as to carry out the control procedures shown in a later described flowchart. The data about the operation results is written in the RAM 13, and data that is written in the RAM 13 and needs to be stored when the power is switched off is written in the NVRAM 14.

The program to be used by the CPU 11 to perform the control operation may be read from a recording medium such as a CD-ROM and be then stored in the NVRAM 14. Also, the program may be transmitted over a communication network and received by the input/output unit 15, and be then stored in the NVRAM 14. The functions of all or some of the other components in the structure shown in FIG. 1 may be realized by software.

The operation panel 5 is connected to the controller 10. This operation panel 5 forms a user interface (UI), and is a display unit device equipped with a so-called touch sensor in this exemplary embodiment. More specifically, the operation panel 5 is formed with a display 5A and an input unit 5B. An operation screen is displayed on the display 5A, and the input unit 5B senses and receives each user operation that is input through the operation screen.

The image input unit 2 is also connected to the controller 10. This image input unit 2 reads an image of a document as digital information. Further, the image output unit 3 is connected to the controller 10. This image output unit 3 forms an image processed by the image processing unit 4 on a paper sheet.

The image processing unit 4 is a unit that performs various image processing operations for digital images. More specifically, the image processing unit 4 has various functions, such as image enlarging/reducing functions, an image rotating function, a function of converting a page description language to an image, and an image interpolating function.

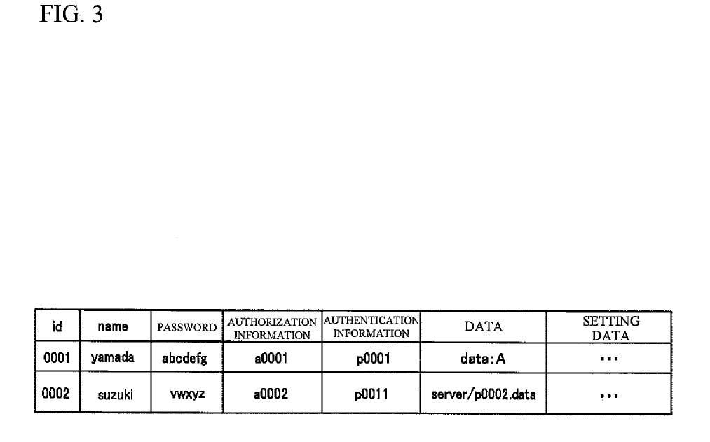

Information about registered users shown in FIG. 3 is registered in the memory 6. The information about the registered users includes IDs for identifying the users, user names, passwords, authorization information indicating the functions of the image forming apparatus 1 the users are allowed to use, authentication information to be used for authentication, URI (Uniform Resource Identifiers) that indicate the data read from the image input unit 2 or its location, the setting data of the image forming apparatus 1 set by each user.

The facsimile transmitting/receiving unit 7 is a unit for transmitting and receiving image data through a telephone line.

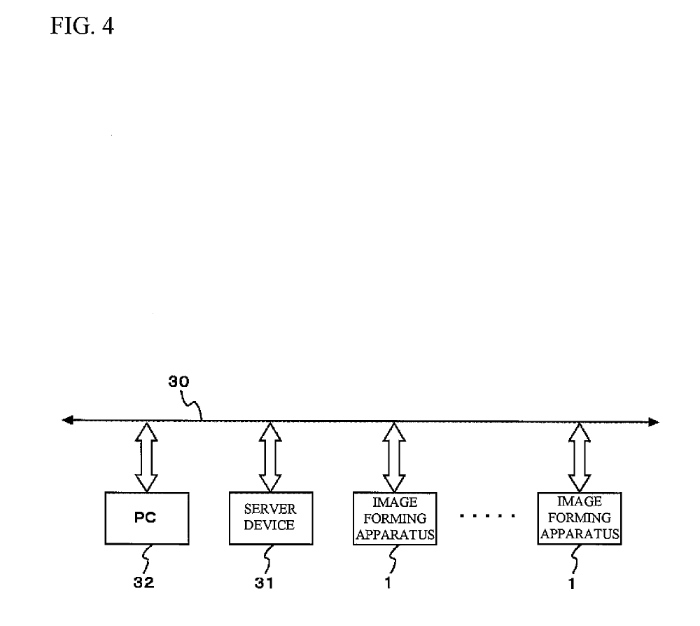

The network communication unit 8 acquires setting data from a server device 31 (see FIG. 4) or another image forming apparatus 1. Customizing the set functions is performed through the operation panel 5 or the like. However, when a change is to be made in the initial setting conditions, a user inputs desired settings through the operation panel 5. Such new setting data may be registered in the image forming apparatus 1, or may be transmitted to and stored in the server device 31 via the network communication unit 8.

FIG. 4 shows the system structure. Image forming apparatuses 1 are connected to a network 30. The server device 31 (equivalent to the management device) and a personal computer (PC) 32 are also connected to the network 30.

The server device 31 stores the setting data that is set for each user, and shared data that can be shared among users. In response to each transfer request from the image forming apparatuses 1, the server device 31 provides the requested data. The PC 32 can make changes (update) in the contents of the setting data stored in the server device 31. Updating the setting data can be performed through any of the image forming apparatuses 1.

In this exemplary embodiment, when operations of any one of the image forming apparatus 1 are set, the setting data set by other users can be referred to, so that the settings of the user can readily reflect the settings that are being used by the other users.

Therefore, the setting data set by each user is registered in the image forming apparatus 1, the server device 31 shown in FIG. 31, and the other image forming apparatuses 1.

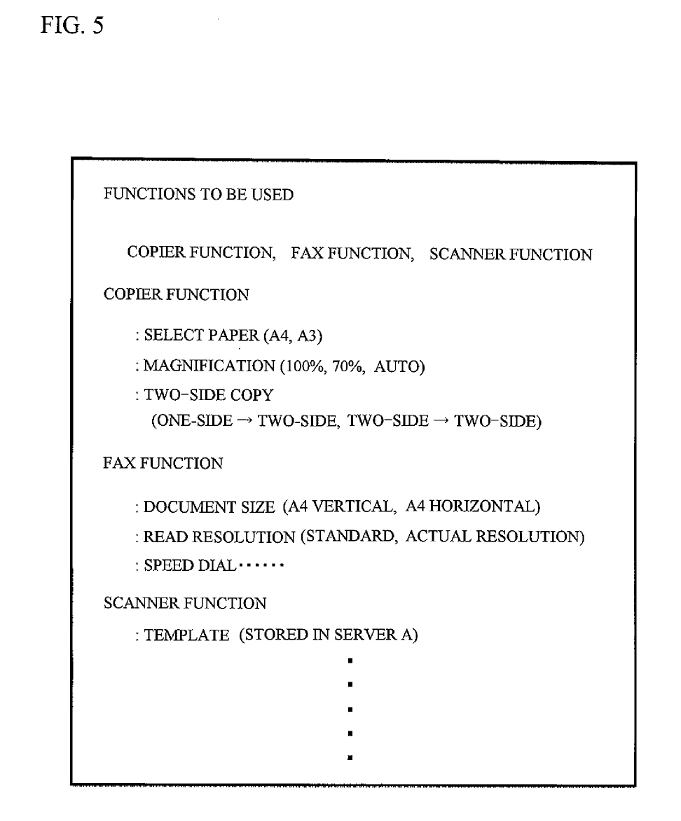

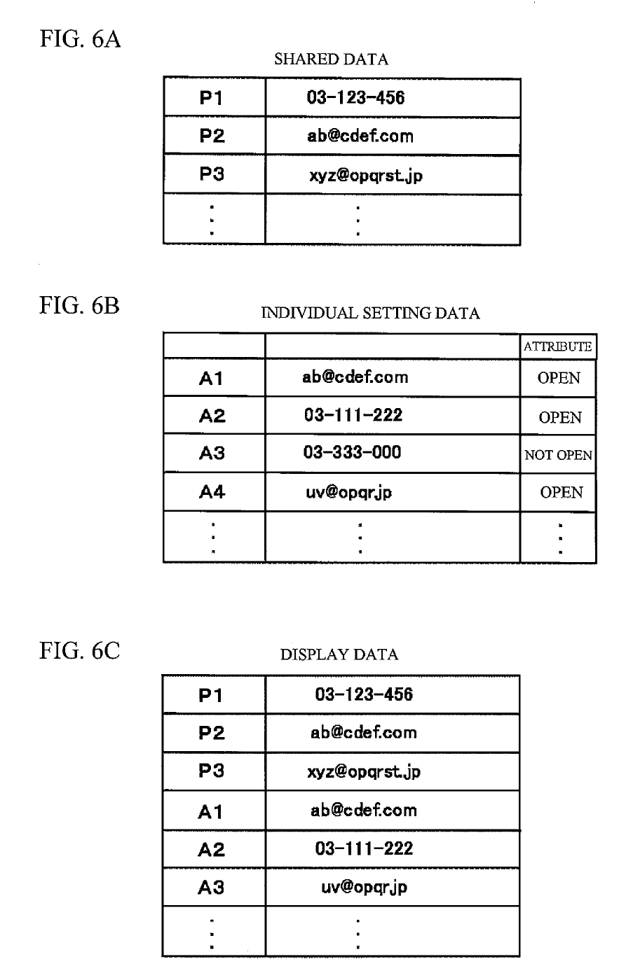

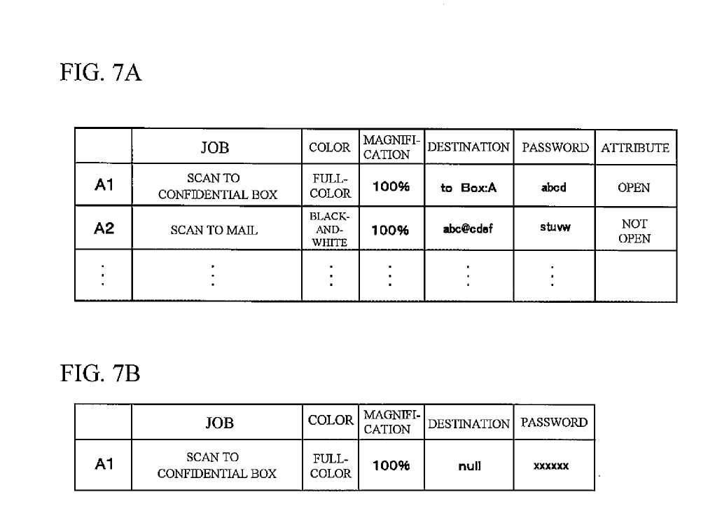

The setting data includes the operation settings for copying, faxing, and scanning in the image forming apparatus (see FIG. 5), telephone book information such as electronic mail addresses (see FIGS. 6A through 6C), and a job template defining a series of operations to be performed by the image forming apparatus 1 in a sequential manner (see FIGS. 7A and 7B). For example, the job template defines a series of registered operations such as scanning an image of an original document, transmitting the image to a predetermined transmission destination (such as a confidential box), and storing the image.

The setting data includes the shared data that is shown in FIG. 6A and is to be shared among all users, and the individual setting data that is shown in FIG. 6B and is to be used by individual users. Additional information indicating whether the individual setting data is open to the public can be added to the individual setting data. Whether the individual setting data is open to the public can be determined in accordance with the authorization of the user who requests acquirement of the setting data.

Upon receipt of a request for a reference to the setting data, the server device 31 and the image forming apparatus 1 perform user authentication to determine whether the user is an authorized user. The user information is performed with the use of the authentication information shown in FIG. 3. If the user is an authorized user, the setting data registered in the server device 31 and the image forming apparatus 1 is displayed. In this case, the displayed setting data includes the shared data and the data set open to the public among the individual setting data, as shown in FIG. 6C.

Upon receipt of a request for the setting data set open to the public, the server device 31 and the image forming apparatus 1 transmit only the data necessary for the user who has made the request, to the image forming apparatus 1 through which the request has been made.

FIG. 7A shows the setting data registered in the server device 31 and the image forming apparatus 1. FIG. 7B shows the setting data to be transmitted to the image forming apparatus 1 through which the request for the setting data has been made. In the example shown in FIGS. 7A and 7B, information such as the password of the user who has created the setting data, and the transmission destination of the scanned data, is the data available only to the creator. Therefore, the corresponding data is deleted or null data is inserted to the corresponding data, and the setting data is transmitted to the image forming apparatus 1.

When obtaining the setting data from the server device or another image forming apparatus 1, the controller 10 of the image forming apparatus 1 requests setting of new data at the portion having the null data inserted thereto. The controller 10 also determines whether the obtained setting data includes the functions the user who has requested the data is not allowed to use. For example, those functions include the setting data of a scanner in a case where the user is not allowed to use the scanner, and those functions include the full-color print settings in a case where the user is not allowed to use full-color printing. If the obtained data includes any of those settings, the controller 10 changes the settings to the settings that can be used by the user, stops updating the setting data, or causes the operation panel 5 to display an alert. For example, in a case where a user who is not allowed to use full-color printing has obtained the setting data for full-color printing, the change of the setting data to the setting data the user is allowed to use is made by replacing the setting data with the setting data for black-and-white printing.

Not only the setting data registered in the server device 31 or other image information apparatuses, but alto the setting data of users registered in the same image forming apparatus 1, can be referred to and reflected in the setting data of the apparatus, as long as the setting data is open to the public.

Other than the above-described examples, the setting data may be used for displaying the settings of the operation panel 5, such as the settings of items to be displayed on the operation panel 5, the settings of items to be displayed on the top screen of the operation panel 5, and the settings of shortcuts for letting each user to select a desired function.

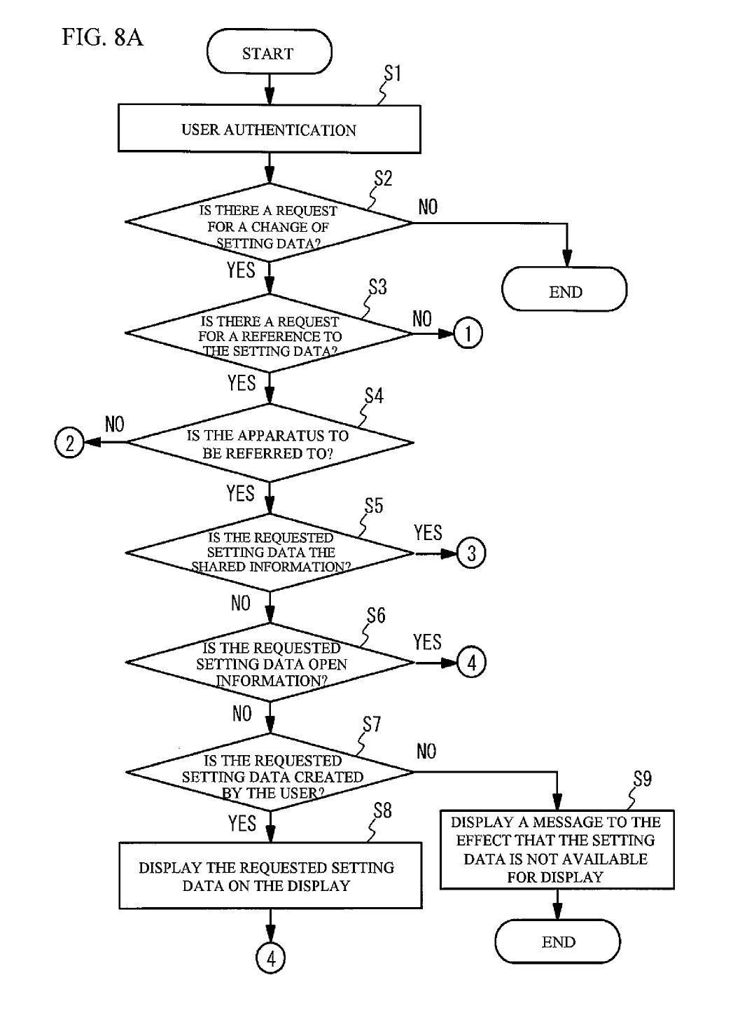

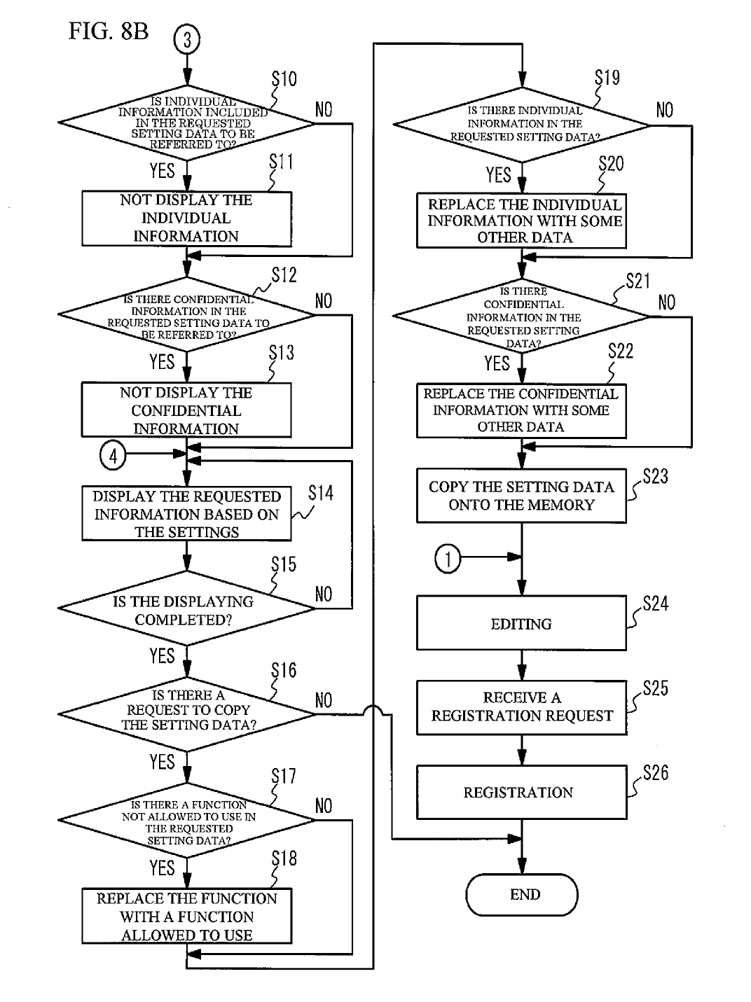

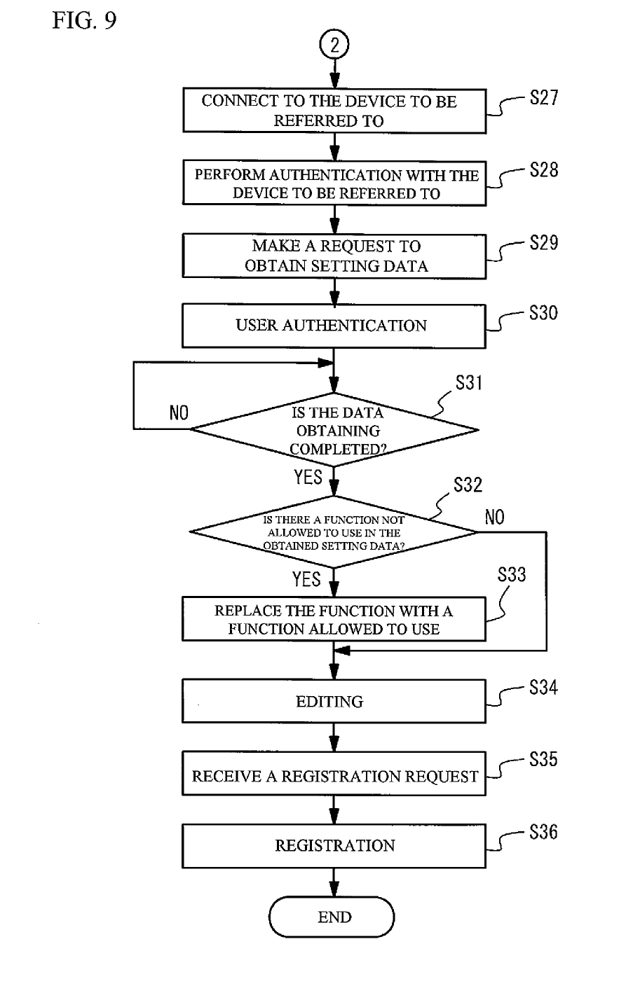

Referring now to the flowcharts shown in FIGS. 8A, 8B and 9, the operation to be performed by the controller 10 is described. FIGS. 8A and 8B are flowcharts showing the procedures to be carried out by the controller 10 in a case where the setting data to be referred to is stored the apparatus.

The controller 10 first causes the operation panel 5 to display a request for an input of a password or ID on the display 5A, and performs user authentication in accordance with the input information (step S1). After properly ending the authentication, the controller 10 determines whether a request for a change of operation settings has been received from the operation panel 5 (step S2). In a case where a request for a change of operation settings has not been received (“NO” in step S2), the controller 10 ends this operation.

In a case where a request for a change of operation settings has been received (“YES” in step S2), the controller 10 determines whether there is a request for a reference to the setting data of another user (step S3). In a case where a request for a reference to the setting data has not been received (“NO” in step S3), the controller 10 displays the setting data of the user registered in the memory 6 on the display 5A of the operation panel 5, and then receives an editing operation from the user (step S24). When a request for registration of edited setting data is received (step S25), the controller 10 registers the edited setting data in the memory 6 (step S26).

In a case where a request for a reference to setting data created by another user has been received (“YES” in step S3), the controller 10 determines whether the setting data to be referred to is stored in the apparatus (step S4). In a case where the setting data to be referred to is not stored in the apparatus, the operation shown in the flowchart in FIG. 9 is performed.

In a case where the setting data to be referred to is stored in the apparatus (“YES” in step S4), the controller 10 determines whether the requested setting data is the shared information to be shared (step S5). In a case where the requested setting data to be referred to is the shared information (“YES” in step S5), the controller 10 determines whether the setting data includes individual information (step S10). If the setting data includes individual data (“YES” in step S10), the controller 10 controls the individual information not to be displayed (step S11). The controller 10 also determines whether the requested setting data includes confidential information such as a password or ID (step S12). If the setting data includes confidential information (“YES” in step S12), the controller 10 controls the confidential information not to be displayed (step S13).

In a case where the requested setting data to be referred to is not the shared information (“NO” in step S5), the controller 10 determines whether the requested setting data to be referred to is information open to the public (step S6). If the requested setting data is not open information (“NO” in step S6), the controller 10 determines whether the requested setting data has been created by the user (step S7). In a case where the setting data has been created by the user (“YES” in step S7), the controller 10 displays the requested data on the display 5A (step S8), and then moves on to step S14. In a case where the setting data is not setting data created by the user (“NO” in step S7), the controller 10 displays a message to the effect that the requested setting data is unavailable on the display 5A (step S9). In a case where the requested setting data is open information, (“YES” in step S6), the controller 10 does not determine whether the setting data includes confidential information or individual information, but immediately moves on to step S14.

The controller 10 causes the operation panel 5 to display the setting data requested in accordance with the settings (step S14). When the display of the setting data on the operation panel 5 is completed (“YES” in step S15), the controller 10 determines whether a request for a copy of the setting data (step S16). In a case where a request for copying the setting data has not been received (“NO” in step S16), the controller 10 ends this operation. In a case where a request for a copy of the setting data has been received (“YES” in step S16), the controller 10 determines whether the requested setting data includes a function that is not allowed to use (step S17). Based on the authorization information shown in FIG. 3, the controller 10 determines whether the setting data includes a function the authenticated user is not allowed to use (step S17). If the setting data includes a function the user is not allowed to use (“YES” in step S17), the controller 10 replaces the function not allowed to use with a function that is allowed to use (step S18). For example, in a case where the user is not allowed to use full-color printing, the controller 10 replaces the setting data with the setting data for black-and-white printing.

The controller 10 also determines whether the requested setting data includes individual information (step S19). If the setting data includes individual information (“YES” in step S19), the controller 10 replaces the individual information with other information (step S20).

The controller 10 also determines whether the requested setting data to be copied includes confidential information (step S21). If the setting data includes confidential information (“YES” in step S21), the controller 10 replaces the confidential information with some other data (step S22). More specifically, the controller 10 inserts null data to the ID and the password.

The controller 10 then associates the referred setting data with the user (ID) who has requested a copy, and registers the referred setting data in the memory 6 (step S23). After the registration of the setting data in the memory 6, the controller 10 receives an editing operation from the user of the registered setting data (step S24). When the editing by the user is finished, and a request for registration is made (step S25), the controller 10 stores the edited setting data in the memory 6 (step S26).

Referring now to the flowchart shown in FIG. 9, the procedures to be carried out in a case where the setting data to be referred to is stored in some other device such as the server device 31 or another image forming apparatus 1 are described.

When the server device 31 or another image forming apparatus 1 in which the setting data to be referred to is stored is designated through the operation panel 5, the controller 10 connects with the designated device (step S27), and performs authentication of the connected device (step S28). More specifically, the controller 10 determines whether the image forming apparatus 1 is registered in the system and is allowed to use registered recourses. When the authentication is successful and a connection is allowed, the controller 10 requests the connected device to obtain the setting data (step S29). The connected device outputs a request for authentication to the image forming apparatus 1, and determines whether the user of the image forming apparatus 1 is a user allowed to obtain the setting data (step S30). Using the ID or password used in step S1, authentication with the connected device (the server device 31 or another image forming apparatus 1) is performed. When the authentication is successful, and the requested setting data is obtained (“YES” in step S31), the obtained setting data is associated with the ID of the user and is stored in the memory 6.

After obtaining the setting data (“YES” in step S31), the controller 10 determines whether the obtained setting data includes a set function the user is not allowed to use (step S32). If the setting data includes a set function not allowed to use (“YES” in step S32), this set function is replaced with a set function the user is allowed to use (step S33). The controller 10 then displays the edited setting data on the display 5A, and receives an editing operation from the user (step S34). When the user editing is ended and a registration request is received (step S35), the controller 10 stores the edited setting data in the memory 6 (step S36).

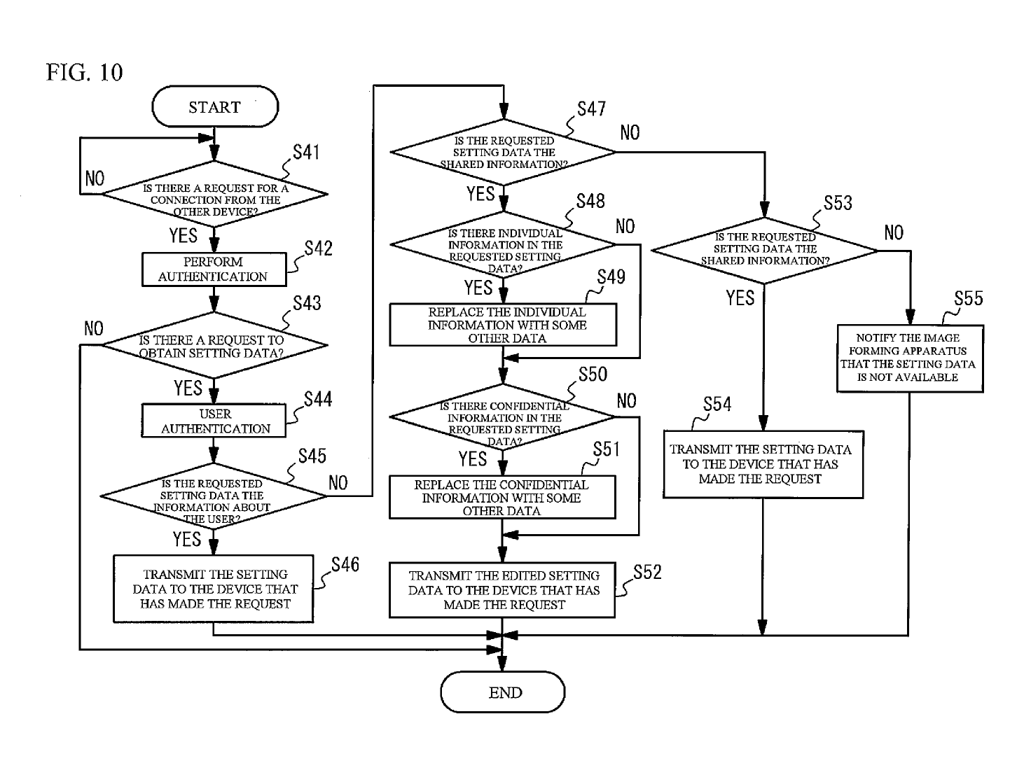

Referring now to the flowchart shown in FIG. 10, the procedures to be carried out by the server device 31 or another image forming apparatus 1 (hereinafter referred to as the other device) that has received a request to obtain the setting data are described.

Upon receipt of a connection request from the image forming apparatus 1 (step S41), the other device performs authentication with the image forming apparatus 1 that has made the connection request (step S42), and determines whether a connection to the image forming apparatus 1 that has made the connection request is allowed. When the authentication is ended successfully, the other device determines whether a request to obtain the setting data has been received from the image forming apparatus 1 (step S43). In a case where a request to obtain the setting data has not received from the image forming apparatus 1 (“NO” in step S43), the other device ends this operation.

In a case where a request to obtain the setting data has been received from the image forming apparatus 1 (“YES” in step S43), the other device outputs a request to obtain user information to the image forming apparatus 1 that has made the setting data acquirement request, and determines whether the user of the image forming apparatus 1 is an authorized user who is allowed to refer to the setting data (step S44). The image forming apparatus 1 then transmits the ID or password obtained in step S1 to the other device. After performing authentication based on the obtained user information, and determining the user of the image forming apparatus 1 is an authorized user, the other device determines whether the requested setting data is data created by the user (step S45). In a case where the requested setting data has been created by the user (“YES” in step S45), the other device immediately transmits the requested setting data to the image forming apparatus 1 (step S46). In a case where the requested setting data is not data the user has created (“NO” in step S45), the other device determines whether the requested setting data is the shared information (step S47).

If the requested setting data is the shared information (“YES” in step S47), the other device determines whether the requested setting data includes individual information (step S48). If the setting data includes individual information (“YES” in step S48), the other device replaces the individual information with some other data (step S49).

The other device also determines whether the requested setting data to be copied includes confidential information (step S50). If the setting data includes confidential information (“YES” in step S50), the other device replaces the confidential information with some other data (step S51). More specifically, the other device inputs null data to the ID and the password.

After performing the editing, the other device transmits the setting data to the image forming apparatus 1 that has made the request to obtain the setting data (step S52).

In a case where the requested setting data is not the shared information (“NO” in step S47), the other device determines whether the setting data is open information (step S53). If the setting data is open information (“YES” in step S53), the other device immediately transmits the setting data to the image forming apparatus 1 (step S54). If the setting data is not open information (“NO” in step S53), the other device notifies the image forming apparatus 1 that the setting data is not available (step S55).

The above-described exemplary embodiment is an example of an exemplary embodiment of the present invention. It should be understood that the present invention is not limited to the above-described exemplary embodiment, and various modifications may be made to them without departing from the scope of the invention.

What is claimed is:

1. An information processing apparatus comprising:
an authenticating unit that authenticate a user;
a registering unit that reads operation setting information registered by a user who is not the authenticated user, and registers the operation setting information as operation setting information of the authenticated user; and
a controller that performs a control operation to prohibit a disclosure or registration of the operation setting information, when the operation setting information registered by the user who is not the authenticated user includes operation setting information that is prohibited from being used by the authenticated user or being disclosed to the authenticated user.

2. The information processing apparatus according to claim 1, wherein the information apparatus is an image forming apparatus.

3. The information processing apparatus according to claim 1, wherein the operation setting information that is prohibited from being used by the authenticated user is function setting information of the information processing apparatus.

4. The information processing apparatus according to claim 1, wherein the operation setting information that is prohibited from being disclosed to the authenticated user is facsimile or e-mail destination information.

5. The information processing apparatus according to claim 1, wherein the operation setting information that is prohibited from being used by the authenticated user or being disclosed to the authenticated user is a confidential box name associated with each user, or a password that is required for using the confidential box.

6. An information processing system comprising:
a memory device that stores operation setting information of an information processing apparatus registered by a user; and
an information processing apparatus that includes: an authenticating unit that authenticate a user; a registering unit that reads operation setting information registered by a user who is not the authenticated user, and registers the operation setting information as operation setting information of the authenticated user; and a controller that performs a control operation to prohibit a disclosure or registration of the operation setting information, when the operation setting information registered by the user who is not the authenticated user includes operation setting information that is prohibited from being used by the authenticated user or being disclosed to the authenticated user.

7. A computer readable recording medium causing a computer to execute a process for processing information, the process comprising:
authenticating a user;
registering operation setting information registered by a user who is not the authenticated user, the operation setting information being registered as operation setting information of the authenticated user; and
performing a control operation to prohibit a disclosure or registration of the operation setting information, when the operation setting information registered by the user who is not the authenticated user includes operation setting information that is prohibited from being used by the authenticated user or being disclosed to the authenticated user.

8. An information processing method comprising:
authenticating a user;
registering operation setting information registered by a user who is not the authenticated user, the operation setting information being registered as operation setting information of the authenticated user; and
performing a control operation to prohibit a disclosure or registration of the operation setting information, when the operation setting information registered by the user who is not the authenticated user includes operation setting information that is prohibited from being used by the authenticated user or being disclosed to the authenticated user.
